(19) United States
(12) Patent Application Publication
(10) Pub. No.: US 2026/0201215 A1
(43) Pub. Date: Jul. 16, 2026

(54) ADHESIVE SHEET, CURED FOAM AND ELECTRIC MOTOR

(71) Applicant: 3M INNOVATIVE PROPERTIES COMPANY, St. Paul, MN (US)

(72) Inventors: Haruna Mizumachi, Tokyo (JP); Kengo Imamura, Machida-city (JP); Jens Eichler, Kaarst (DE); Patricia J. Tegeder, Düsseldorf (DE); John Jackowski, Livonia, MI (US)

(21) Appl. No.: 19/133,448

(22) PCT Filed: Dec. 6, 2023
(86) PCT No.: PCT/IB2023/062333

§ 371 Date: May 28, 2025

(30) Foreign Application Priority Data
Dec. 16, 2022 (JP) 2022-201217

(51) Int. Cl. C09J 9/00; B32B 7/12; B32B 15/01; C09J 7/30; C09J 11/04; H02K 1/16; H02K 3/12

(52) U.S. Cl. CPC C09J 9/00; B32B 7/12; B32B 15/01; C09J 7/30; C09J 11/04; H02K 1/16; H02K 3/12; B32B 2457/00; C09J 2203/326; C09J 2301/124

(57) ABSTRACT

An adhesive sheet is provided having an expandable adhesive layer having a foaming agent and excellent thermal conductivity after foaming curing. The adhesive sheet comprises a substrate, a first adhesive layer disposed on one surface of the substrate, and a second adhesive layer disposed on the other side of the substrate. The first adhesive layer comprises an adhesive (A), a thermally conductive filler (B) having a mean short side length of 1 μm or more, and a foaming agent (C). The thermally conductive filler (B) has an aspect ratio of 1.3 or more and includes a filler (B-1). The second adhesive layer contains an adhesive (A′), a thermally conductive filler (B′) having a mean short side length of 1 μm or more, and a foaming agent (C′). The thermally conductive filler (B′) p comprises a filler (B′-1) having an aspect ratio of 1.3 or more.

### TECHNICAL FIELDS

The present invention relates to an electric motor including an adhesive sheet, a cured foam body of an adhesive sheet, and a cured foam body of an adhesive sheet.

### BACKGROUND

Conventionally, adhesive sheets have been used to bond the objects to be adhered to, and adhesive sheets having various configurations have been studied according to their applications, required characteristics, and the like.

For example, WO 2016/163514 discloses an epoxy resin containing a polyfunctional epoxy resin, a phenolic resin as a curing agent, an imidazole compound as a curing catalyst, and an adhesive sheet having an expansive adhesive layer formed by containing a temperature-sensitive blowing agent as an adhesive sheet for fixing the stator core and the winding.

### SUMMARY

The expandable adhesive layer is useful in that it can fill the gap between the objects to be adhered, but since a void occurs in the adhesive layer as it expands, it is difficult to obtain sufficient thermal conductivity after expansion.

The present disclosure relates to an adhesive sheet having an expandable adhesive layer having a foaming agent and having excellent thermal conductivity after foaming curing. Further, the present disclosure relates to a foam-cured product of the adhesive sheet and having high thermal conductivity. Furthermore, the present disclosure relates to an electric motor comprising the cured foam body and having a stator having good heat dissipation.

One aspect of the present disclosure relates to an adhesive sheet, comprising a substrate, a first adhesive layer disposed on one surface of the substrate, and a second adhesive layer disposed on the other surface of the substrate. The first adhesive layer includes an adhesive (A), a thermally conductive filler (B) having a mean short side length of 1 μm or more, and a foaming agent (C), and the content of the thermally conductive filler (B) is 1% by volume or more and 37% by volume or less based on the total volume of the first adhesive layer. The thermally conductive filler (B) includes a filler (B-1) having an aspect ratio of 1.3 or more. The second adhesive layer includes an adhesive (A′), a thermally conductive filler (B′) having an mean short side length of 1 μm or more, and a foaming agent (C′), and the content of the thermally conductive filler (B′) is based on the total volume of the second adhesive layer, 1% by volume or more and 37% by volume or less, and the thermally conductive filler (B′) includes a filler (B′-1) having an aspect ratio of 1.3 or more.

Since the first adhesive layer and the second adhesive layer expand by arranging such adhesive sheets between the objects to be adhered and then heating them, the objects to be adhered can be bonded to each other while filling between the objects to be adhered. Further, since the first adhesive layer and the second adhesive layer have expandability, the thickness of the adhesive sheet may be thinner than the gap between the objects to be adhered. For this reason, the adhesive sheet is easily arranged between the objects to be adhered.

Further, in the adhesive sheet, the first adhesive layer and the second adhesive layer contain a predetermined amount of a thermally conductive filler, and at least a part of the thermally conductive filler is an aspect ratio of 1.3 or more. One of the reasons why such an effect is achieved is that the aspect ratio of the filler is high, so even if the space between the bubbles generated during expansion is narrow, this is considered to be because a heat conduction path from one surface side to the other side of the adhesive layer is easily formed. In the adhesive sheet, due to the formation of such a heat conduction path, a high expansion magnification (for example, 1.4 times or more) even when foam-cured, a cured foam body having high thermal conductivity can be obtained.

Another aspect of the present disclosure relates to an electric motor comprising a stator. The stator is comprising a stator core having at least one slot, a winding at least a part of the winding is received to the above slot, and an adhesive layer for adhering the stator core and the winding. The adhesive layer includes the cured foam body of the above-described adhesive sheet.

The adhesive sheet of the present disclosure includes an expandable adhesive layer having a foaming agent, and is excellent in thermal conductivity after foaming curing. Further, the foam-cured product of the present disclosure is a foam-cured product of the adhesive sheet and has high thermal conductivity. Furthermore, the electric motor of the present disclosure includes the cured foam body and includes a stator having good heat dissipation.

### BRIEF DESCRIPTION OF THE DRAWINGS

FIG. 1 is sectional view which shows one aspect of the adhesive sheet.

FIG. 2 is a cross-sectional view which shows another aspect of the adhesive sheet.

FIG. 3 is sectional drawing which shows one aspect of the foamed cured body.

### DETAILED DESCRIPTION

Hereinafter, with reference to the drawings, a preferred embodiment of the present invention will be deferred. In the description of the drawings, the same elements are denoted by the same numerals, and duplicate explanations are omitted. In addition, a part of the drawing is exaggerated for ease of understanding, and the dimensional ratio is not limited to what is described in the drawing.

The adhesive sheet of the present embodiment includes a substrate, a first adhesive layer disposed on one surface of the substrate, and a second adhesive layer disposed on the other surface of the substrate.

The first adhesive layer includes an adhesive (A), a thermally conductive filler (B) having a mean short side length of 1 μm or more, and a foaming agent (C). The second adhesive layer includes an adhesive (A′), a thermally conductive filler (B′) having a mean short side length of 1 μm or more, and a foaming agent (C′).

The content of the thermally conductive filler (B) is 1% by volume or more and 37% by volume or less based on the total volume of the first adhesive layer, and the thermally conductive filler (B) includes a filler (B-1) having an aspect ratio of 1.3 or more.

The content of the thermally conductive filler (B′) is 1% by volume or more and 37% by volume or less based on the total volume of the second adhesive layer, and the thermally conductive filler (B′) includes a filler (B′-1) having an aspect ratio of 1.3 or more.

In this specification, the aspect ratio indicates the ratio of the mean long side length to the mean short side length. The mean short side length is the mean length of the short side of the bounding rectangle (smallest bounding rectangle) with the smallest area among the bounding rectangles of the particle projection image observed by the transmission electron microscope. Further, the mean long side length indicates the mean length of the long side of the circumscribed rectangle (smallest bounding rectangle) having the smallest area among the bounding rectangles of the particle projection image observed by the transmission electron microscope. The mean length of the short side and the long side is a mean value obtained by measuring the short side and long side of 50 or more fillers in total, 10~30 per image, by acquiring at least three observation images of a transmission electron microscope for one type of filler.

Since the adhesive sheet of the present embodiment expands the first adhesive layer and the second adhesive layer by placing it between the objects to be adhered and then heating them, the adhesive sheets can be bonded the objects to be adhered to each other while filling between the objects to be adhered. Further, since the adhesive sheet of the present embodiment has an expansive first adhesive layer and a second adhesive layer, it may be thinner than the gap between the objects to be adhered to, and it is easy to arrange between the objects to be adhered.

Further, in the adhesive sheet of the present embodiment, the first adhesive layer and the second adhesive layer contain a predetermined amount of a thermally conductive filler, and at least a part of the thermally conductive filler is an aspect ratio. Since it is a filler having a 1.3 or more, a cured foam body having high thermal conductivity can be formed after foaming curing. One of the reasons why such an effect is achieved is that the aspect ratio of the filler is high, and even if the space between the bubbles generated during expansion and the bubbles is narrow, a heat conduction path from one side to the other side of the adhesive layer is easily formed. In the adhesive sheet of the present embodiment, due to the formation of such a heat conduction path, a high expansion magnification (for example, 1.4 times or more) even when foam-cured, a cured foam body having high thermal conductivity can be obtained.

The adhesive sheet of the present embodiment may further include a first adhesive permeable layer arranged on the first adhesive layer. Further, the adhesive sheet of the present embodiment may further include a second adhesive permeable layer disposed on the second adhesive layer. The first adhesive permeable layer is a layer that can permeate the adhesive (A) when the first adhesive is foamed, and the second adhesive permeable layer is a layer that can permeate the adhesive (A′) when the second adhesive foams.

When the adhesive sheet of the present embodiment includes a first adhesive permeable layer and a second adhesive permeable layer, when the adhesive sheet is placed between the objects to be adhered and then heated, the first adhesive layer and the second adhesive layer begin thermal expansion, and the adhesive (A) oozes onto the outer surface of the first adhesive permeable layer, and the adhesive (A′) oozes onto the outer surface of the second adhesive permeable layer. Thereby, the adhesive can reach the outside of the first adhesive permeable layer and the second adhesive permeable layer that were in the outermost layer before heating, and the objects to be adhered to each other can be bonded. Before heating the adhesive sheet, that is, when the adhesive sheet is positioned with respect to the object to be adhered, the first adhesive permeation layer and the second adhesive permeable layer are arranged on the outermost layer of the adhesive sheet.

Further, the first adhesive permeable layer and the second adhesive permeable layer can also function as members that suppress the spread of the adhesive (A) and the adhesive (A′) in the surface direction when the first adhesive layer and the second adhesive layer expand.

Hereinafter, each configuration of the adhesive sheet of the present embodiment will be described in detail.

### Substrate

The substrate is a base portion for forming the first adhesive layer and the second adhesive layer, and it is a member that substantially defines the size of the adhesive surface of the adhesive sheet.

The substrate functions as a base for forming a first adhesive layer and a second adhesive layer in the manufacturing stage of the adhesive sheet. For this reason, the material constituting the substrate is strong enough to support the first adhesive layer and the second adhesive layer, and any material may be used as long as the material does not reduce the adhesive strength during expansion (for example, when heating) of the first adhesive layer and the second adhesive layer.

Further, when the adhesive sheet of the present embodiment is used for an application requiring electrical insulation, electrical insulating properties can be easily imparted to the adhesive sheet by selecting an insulating substrate as the substrate.

The material constituting the substrate is not particularly limited, but from the viewpoint of being excellent in strength, heat resistance and electrical insulation, and being particularly useful as a slot liner for the stator core of an electric motor, a polyester resin (for example, polyethylene naphthalate (PEN), polyethylene terephthalate (PET)), polycarbonate resin, polyimide resin (eg, polyetherimide (PEI), Polyamide-imide and the like), polyamide resin (for example, polyetheramide, polyaramid, nylon, etc.), acrylic resin, polysulfone resin (polysulfone, polyethersulfone, etc.), polyetherketone resin (polyetherketone, polyetheretherketone, etc.), modified polyphenylene oxide and the like are preferable. The substrate may contain only one of these, or may contain two or more.

The thickness of the substrate may be appropriately adjusted according to the spacing between the objects to be adhered. When the gap between the objects to be adhered is large, it is easy to fill the gap by increasing the thickness of the substrate. The thickness of the substrate may be, for example, 2 μm or more, and from the viewpoint that the breakdown voltage is likely to be improved, it may be 3 μm or more, 5 μm or more, 7 μm or more, 9 μm or more, or 11 μm or more. Further, the thickness of the substrate may be, for example, 200 μm or less, 150 μm or less, 100 μm or less, or 90 μm or less from the viewpoint of flexibility of the adhesive sheet.

### First Adhesive Layer

The first adhesive layer is disposed on one surface of the substrate and includes the adhesive (A), a thermally conductive filler (B) having a mean short side length of 1 μm or more, and a foaming agent (C). Since the first adhesive layer contains a foaming agent (C), it expands when the objects to be adhered to each other can fill the gap between the objects to be adhered to.

As the adhesive (A), for example, a material that is substantially a solid state at room temperature, flowable by heating, and can be cured by further continuing heating may be used.

That is, the adhesive (A) may be a thermosetting adhesive. Examples of such an adhesive include an epoxy adhesive or the like.

The adhesive (A) may contain a thermosetting resin. For example, when the adhesive (A) is an epoxy adhesive, the adhesive (A) may contain a thermosetting epoxy resin.

Examples of the thermosetting epoxy resin include a bisphenol type epoxy resin (for example, a bisphenol A type epoxy resin, a bisphenol F type epoxy resin, etc.), an aliphatic epoxy resin (for example, hexanediol diglycidyl ether, etc.), glycidylamine epoxy resins (e.g., triglycidylaminophenols, etc.), novolac epoxy resins (e.g., phenol novolac epoxy resins, cresol novolac epoxy resins, etc.), alicyclic epoxy resins (e.g., 3,4-epoxycyclohexylmethyl, 3,4-epoxycyclohexanecarboxylate), bis (3, 4-epoxycyclohexyl methyl adipate), brominated epoxy resins (for example, tetrabromobisphenol A diglycidyl ether, etc.), polyfunctional epoxy resins (eg, tris (hydroxyphenyl) methane triglycidyl ether, sorbitol polyglycidyl ether, tetraglycidyldiaminodiphenylmethane, etc.), crystalline epoxy resins (e.g., tetramethylbisphenol F diglycidyl ether, tetramethylbiphenol diglycidyl ether etc.). These may be used alone, or two or more may be used in combination.

The adhesive (A) may further contain a curing agent. The curing agent may be any curing agent capable of curing the thermosetting resin, and may be appropriately selected from known curing agents. As the curing agent, a potential curing agent is preferable from the viewpoint of avoiding curing before foaming of the foaming agent (C).

When the adhesive (A) is an epoxy adhesive, the curing agent includes, for example, dicyandiamide, 2,4-diamino-6-[2′-metimidazolyl-(1′)]-ethyl-s-thoryazine isocyanuric acid adduct, and the like.

The content of the curing agent may be appropriately adjusted according to the type of thermosetting resin and the type of curing agent. The content of the curing agent may be, for example, 1 part by mass or more, 2 parts by mass or more, 3 parts by mass or more, 4 parts by mass or more, or 5 parts by mass or more with respect to 100 parts by mass of the thermosetting resin. The content of the curing agent may be, for example, 20 parts by mass or less, with respect to 100 parts by mass of the thermosetting resin, 18 parts by mass or less, 16 parts by mass or less, 14 parts by mass or less, 12 parts by mass or less, or 10 parts by mass or less.

The adhesive (A) may further contain a curing accelerator. The curing accelerator may be as long as it can promote curing with a thermosetting resin curing agent, and may be appropriately selected from known curing accelerators.

When the adhesive (A) is an epoxy adhesive, the curing accelerator includes, for example, an imidazole curing accelerator (for example, 2,4-diamino-6-[2′-methylimidazolyl-(1′)]-ethyl-s-triazine, etc.), a urea curing accelerator (for example, 4,4′-Methylenebisphenyldimethylurea, 3-(3,4-dichlorophenyl)-1,1-dimethylurea, etc.) and the like.

The content of the hardening promoter may be appropriately adjusted according to the type of thermosetting resin and the type of curing agent. The content of the curing accelerator may be, for example, 0.1 parts by mass or more, 0.2 parts by mass or more, 0.3 parts by mass or more, 0.4 parts by mass or more, or 0.5 parts by mass or more. The content of the curing accelerator may be, for example, 10 parts by mass or less, 8 parts by mass or less, 6 parts by mass or less, 4 parts by mass or less, or 2 parts by mass or less with respect to 100 parts by mass of the thermosetting resin.

The adhesive (A) may further contain a thermoplastic resin.

The adhesive (A) may further contain other components other than the above. Other components include a silane coupling agent and the like.

The thermally conductive filler (B) is a filler having an mean short side length of 1 μm or more.

Fillers with a mean short side length of less than 1 μm have a low contribution to thermal conductivity and are difficult to function as thermally conductive fillers. The mean short side length of the thermal conductive filler (B) is 1 μm or more, and may be 1.5 μm or more or 2 μm or more from the viewpoint of a greater contribution to thermal conductivity. The mean short side length of the thermally conductive filler (B) may be, for example, 100 μm or less, 90 μm or less, 80 μm or less, or 70 μm or less.

The content of the thermal conductive filler (B) is 1% by volume or more based on the total volume of the first adhesive layer, and from the viewpoint of further improving the thermal conductivity of the foam-cured product, it may be 3% by volume or more, 5% by volume or more, or 10% by volume or more. The content of the thermally conductive filler (B) is 37% by volume or less based on the total volume of the first adhesive layer, and from the viewpoint of further improving the adhesive strength with the adherend, it may be 35% by volume or less or 33% by volume or less.

Further, when the adhesive sheet has a first adhesive permeable layer, the adhesive (A) easily permeates the first adhesive permeable layer, and from the viewpoint of high adhesive strength with the object to be easily obtained, the content of the thermally conductive filler (B) is 30% by volume or less, 27% by mass or less, 25% by mass or less, 23% by mass or less, 21% by mass or less, 19% by mass or less. It may be 17% by mass or less or 15% by mass or less.

The material of the thermally conductive filler (B) is not particularly limited, and can be appropriately selected from known thermally conductive fillers. The thermally conductive filler (B) may include, for example, at least one selected from the group consisting of, for example, boron nitride, aluminum nitride, alumina, magnesium oxide, anhydrous magnesium carbonate, magnesium hydroxide, silicon oxide, and silicon nitride.

The thermally conductive filler (B) may include a filler (B-1) having an aspect ratio of 1.3 or more. Since such a filler (B-1) has a high aspect ratio, it is easy to form a heat conduction path from one side to the other side of the adhesive layer even when the space between the bubble generated during expansion and the bubble is narrow. For this reason, according to the filler (B-1), even when foam-cured at a high expansion magnification (for example, 1.4 times or more), a foam-cured product having high thermal conductivity can be obtained.

The shape of the filler (B-1) is not particularly limited as long as it satisfies the aspect ratio, but may be, for example, a platelet shape, a whisker shape, an agglomerate shape, or the like.

The aspect ratio of the filler (B-1) may be, for example, 1.4 or more, 1.5 or more, or 1.6 or more from the viewpoint of playing the above effect more remarkably.

The aspect ratio of the filler (B-1) may be, for example, 200 or less, 150 or less, or 100 or less.

When the filler (B-1) is platelet or agglolate, the aspect ratio of the filler (B-1) may be, for example, 50 or less, 30 or less, 10 or less, 5 or less or 3 or less. When the filler (B-1) is whisker-like, the aspect ratio of the filler (B-1) may be, for example, more than 50, 60 or more, 70 or more, 80 or more, or 90 or more.

The mean short side length of the filler (B-1) may be the same as the mean short side length of the thermally conductive filler (B).

In the present embodiment, a heat conduction path is efficiently formed between bubbles and bubbles by a filler (B-1) having a high aspect ratio. The thermally conductive filler (B) may be at least a part of the filler (B-1) and may be entirely a filler (B-1).

From the viewpoint of forming more heat conduction paths, the content of the filler (B-1) may be, for example, 0.01% by volume or more, based on the total volume of the first adhesive layer, 0.05% by volume or more, 0.1% by volume or more, or 0.15% by volume or more.

The thermally conductive filler (B) may further include a filler (B-2) having an aspect ratio of less than 1.3. That is, the thermally conductive filler (B) may include a filler (B-1) having an aspect ratio of 1.3 or more and a filler (B-2) having an aspect ratio of less than 1.3.

The ratio of filler (B-1) to the thermally conductive filler (B) may be, for example, 0.1% by volume or more based on the total volume of the thermally conductive filler (B), and from the viewpoint of forming a heat conductive path more efficiently, it may be 0.3% by volume or more, 0.5% by volume or more, 0.7% by volume or more, or 1% by volume or more.

When the aspect ratio of the filler (B-1) exceeds 50 (for example, when the filler (B-1) is whisker-shaped), the ratio of the filler (B-1) to the thermally conductive filler (B) is based on the total volume of the thermally conductive filler (B), for example, 100% by volume or less, 50% by volume or less, 30% by volume or less. It may be 10% by volume or less, 5% by volume or less, or 3% by volume or less.

When the aspect ratio of the filler (B-1) is 50 or less (for example, when the filler (B-1) is platelet-shaped or agglomerate), the ratio of filler (B-1) to the thermally conductive filler (B) is 10% by volume or more, 30% by volume or more, 50% by volume or more. It may be 70% by volume or more, 90% by volume or more, or may be 100% by volume.

The foaming agent (C) may be any foaming agent that foams when adhering to the object to be adhered to and can expand the adhesive layer. The foaming agent (C) is preferably a temperature-sensitive blowing agent.

Examples of the foaming agent (C) include inorganic blowing agents such as ammonium carbonate, ammonium hydrogen carbonate, ammonium nitrite, ammonium borohydride, and azides; alkanes fluoride such as trichloromonofluoromethane, azo compounds such as azobis isobutyronitrile, hydrazine compounds such as paratoluenesulfonyl hydrazide, Semicarbazide compounds such as p-toluenesulfonylsemicarbazide, triazole compounds such as 5-morpholyl-1,2,3,4-thiatriazole, N, N-organic foaming agents such as N-nitroso compounds such as dinitrosoterephthalamide; Thermal expansion microcapsules obtained by microencapsulating a thermal leavening agent (for example, a hydrocarbon compound), and the like. Among these, thermal expansion particles (C-1) are preferable from the viewpoint of not easily inhibiting the curing of the adhesive (A).

Thermal expansion particles (C-1) may be comprising, for example, a thermoplastic shell and leavening agent (for example, liquid hydrocarbons) encapsulated in the shell. Examples of thermal expansion particles (C-1) include each series of Matsumoto Microsphere (registered trademark) (manufactured by Matsumoto Yushi-Seiyaku Co., Ltd) and the like.

The foaming start temperature (Tc) of the foaming agent (C) may be, for example, 90° C. or higher, and from the viewpoint that foaming tends to start after the adhesive (A) is sufficiently soft, 95° C. or higher or 100° C. or higher. Further, the foaming start temperature (Tc) of the foaming agent (C) may be, for example, 140° C. or lower, and from the viewpoint that a sufficient expansion magnification can be easily obtained before curing the adhesive (A), it may be 135° C. or lower or 130° C. or lower.

The content of the foaming agent (C) may be a content capable of achieving the expansion magnification described later. The content of the foaming agent (C) may be, for example, 0.5 parts by mass or more, 1 part by mass or more, 3 parts by mass or more, or 5 parts by mass or more with respect to 100 parts by mass of the thermosetting resin. The content of the foaming agent (C) may be, for example, 30 parts by mass or less, 25 parts by mass or less, or 20 parts by mass or less.

The first adhesive layer foams and cures by heating. The foaming magnification of the first adhesive layer is not particularly limited, and may be appropriately determined according to the thermal conductivity and adhesive strength required for the foam-cured product, the distance between the objects to be adhered, and the like. The foaming magnification of the first adhesive layer may be, for example, 1.5 times or more, 2 times or more, 2.5 times or more, or 3 times or more. Further, the foaming magnification of the first adhesive layer may be, for example, 10 times or less, 9 times or less, 8 times or less, or 7 times or less. The larger the foaming magnification, the more voids generated by foaming, and the lower the thermal conductivity after foaming curing. In the present specification, the foaming magnification of the first adhesive layer is a value obtained as the ratio of the thickness of the first adhesive layer before and after foaming curing.

The foaming magnification of the first adhesive layer can be appropriately adjusted by, for example, the content of the foaming agent (C) and the like.

The first adhesive layer may further contain other components other than the adhesive (A), the thermally conductive filler (B), and the foaming agent (C). Other components include, for example, a thickener, an impact resistance improver, and the like.

Examples of the thickener include fumed silica and the like.

The content of the thickener is not particularly limited. The first adhesive layer may be formed by applying and drying a coating solution containing an adhesive (A), a thermally conductive filler (B), a foaming agent (C), and a solvent. The thickener may be blended so that the viscosity of the coating solution becomes a viscosity suitable for application, and the content of the thickener is the viscosity of the coating solution. The content of the thickener may be, for example, 5% by mass or less, based on the total amount of components other than the thermally conductive filler (B) of the first adhesive layer, 3% by mass or less, 2.5% by mass or less, or it may be 2% by mass or less. Further, the content of the thickener may be, for example, 0.1% by mass or more, based on the total amount of components other than the thermally conductive filler (B) of the first adhesive layer, 0.3% by mass or more, 0.5% by mass or more. It may be 0.7% by mass or more or 1% by mass or more.

Examples of the impact resistance modifier include a core-shell type impact resistance improver. Examples of the core-shell type impact resistance improver include core-shell rubber.

The core shell rubber contains different materials for the inner core part and the outer shell part, respectively. The glass transition temperature (Tg) of the shell portion is preferably higher than the Tg of the core portion. The Tg of the core portion may be, for example, −110° C.~−30° C., and the Tg of the shell portion may be, for example, 0° C.~200° C. In the present specification, Tg of the core portion and the shell portion is defined as the temperature of the peak value of tan δ in dynamic viscoelasticity measurement. The impact resistance is improved by the core portion of the core shell rubber acting as a stress concentration point, and the shell portion suppresses undesirable aggregation between the core shell rubbers so that the core shell rubber is uniformly distributed.

The core shell rubber is, for example, a polymer of conjugated dienes such as butadiene, isoprene, 1,3-pentadiene, cyclopentadiene, dicyclopentadiene; polymers of unconjugated dienes such as 1,4-hexadiene, ethylidenenorbornene; copolymer of conjugated diene or unconjugated diene and monofunctional monomer (for example, aromatic vinyl compounds such as styrene, vinyltoluene, and α-methylstyrene, unsaturated nitrile compounds such as acrylonitrile and methacrylonitrile, (meth) acrylate such as 2-hydroxyethyl acrylate, 2-hydroxyethyl methacrylate, etc.); acrylic rubber such as polybutyl acrylate; silicone rubber; IPN-type composite rubber composed of silicone and polyalkyl acrylate; a core moiety containing a rubber component such as and a shell moiety formed by copolymerizing (meth) acrylic acid ester around the core portion, a core-shell type graft copolymer may be provided. As the core portion, a polybutadiene, butadiene-styrene copolymer, and an acrylic/butadiene rubber-styrene copolymer can be advantageously used, and as the shell portion, a one formed by copolymerizing methyl (meth) acrylate can be advantageously used. The shell portion may be layered and may be composed of one layer or a plurality of layers. As the core shell rubber, two or more types of core shell rubber may be used in combination.

Examples of the core shell rubber include methyl methacrylate-butadiene copolymer, methyl methacrylate-butadiene-styrene copolymer, methyl methacrylate-acrylonitrile-butadiene-styrene copolymer, methyl methacrylate-acrylic rubber copolymer, methyl methacrylate-acrylic rubber-styrene copolymer, methyl methacrylate-acrylic/butadiene rubber copolymer, methyl methacrylate-acrylic/butadiene rubber-styrene copolymer, methyl methacrylate-(acrylic/silicone IPN rubber) copolymer and the like. Among these, methyl methacrylate-butadiene copolymer, methyl methacrylate-butadiene-styrene copolymer, and methyl methacrylate-acrylic-butadiene rubber-styrene copolymer can be advantageously used as the core shell rubber.

The mean value (mass mean particle size) of the primary particle diameter of the core shell rubber may be, for example, 0.05 μm or more, or may be 0.1 μm or more. Further, the mean value (mass mean particle size) of the primary particle diameter of the core shell rubber may be, for example, 5 μm or less, and may be 3 μm or less or 1 μm or less. The mean value of the primary particle size of the core shell rubber is calculated from the value obtained by the zeta potential particle size distribution measurement.

The content of the impact resistance improver is not particularly limited, and may be, for example, 20% by mass or less, 15% by mass or less or 10% by mass based on the total amount of components other than the thermal conductive filler (B) of the first adhesive layer. Further, the content of the impact resistance improver may be, for example, 1% by mass or more, based on the total amount of components other than the thermally conductive filler (B) of the first adhesive layer, and may be 2% by mass or more, or 3 parts by mass or more.

The first adhesive layer may be formed by applying and drying a first coating solution containing each of the above-described components and a solvent on a substrate.

The solvent is not particularly limited, and the adhesive (A) can be dissolved, and the solvent that can be removed without curing the adhesive (A) may be used. Examples of such a solvent include methyl ethyl ketone, acetone, toluene and the like.

The thickness of the first adhesive layer is not particularly limited, and may be, for example, 5 μm or more, 10 μm or more, or 15 μm or more. Further, the thickness of the first adhesive layer is not particularly limited, for example, may be 200 μm or less, and from the viewpoint of good workability, it may be 100 μm or less, 80 μm or less, or 60 μm or less.

### Second Adhesive Layer

The second adhesive layer is disposed on the opposite surface of the substrate and includes an adhesive (A′), a thermally conductive filler (B′) having a mean short side length of 1 μm or more, and a foaming agent (C′). Since the second adhesive layer contains a foaming agent (C′), it expands when the objects to be adhered to each other can fill the gap between the objects to be adhered to.

Each configuration of the second adhesive layer may be similar to each configuration of the first adhesive layer.

For example, the adhesive (A′) can be exemplified as the same as the adhesive (A).

Examples of the thermally conductive filler (B′) are the same as those of the thermal conductive filler (B). The thermally conductive filler (B′) may contain a filler (B′-1) having an aspect ratio of 1.3 or more, and may contain a filler (B′-2) having an aspect ratio of less than 1.3. Examples of the filler (B′-1) and filler (B′-2) are the same as those of the filler (B-1) and the filler (B-2).

Examples of the foaming agent (C) are the same as those of the foaming agent (C′). The foaming agent (C′) may contain thermal expansion particles (C′-1). Examples of the thermal expansion particles (C′-1) are the same as those of the thermal expansion particles (C-1).

The content of each component in the second adhesive layer may be the same as the content of each component in the first adhesive layer.

### First Adhesive Permeable Layer

The first adhesive permeable layer causes the adhesive (A) to pass through from one main surface side of the first adhesive permeable layer to the other main surface side when the first adhesive layer expands (foams).

The first adhesive permeable layer may have a plurality of holes that penetrate from one main surface to the other. In this case, when the first adhesive layer that is in contact with only one main surface of the first adhesive permeable layer expands (foams), the adhesive (A) can reach the other main surface of the first adhesive permeable layer through the holes.

The material constituting the first adhesive permeable layer is not particularly limited, and may be a material that can maintain a shape for permeating the adhesive (A) at the curing start temperature of the adhesive (A).

The first adhesive permeable layer may be, for example, a nonwoven fabric composed of natural fibers, chemical fibers, or mixtures thereof. Since the nonwoven fabric has a large number of through holes inside, the above effect can be obtained remarkably.

The weighing of the first adhesive permeable layer may be, for example, 10 g/m² or more, and may be 11 g/m² or more. The upper limit of the weighing limit of the first adhesive permeable layer is not particularly limited, and may be within a range satisfying, for example, the thickness range of the first adhesive permeable layer described later.

The thickness of the first adhesive permeable layer may be, for example, 55 μm or less, and from the viewpoint that the amount of adhesive (A) that oozes on the surface when the first adhesive layer expands and a higher adhesive strength can be obtained, it may be 50 μm or less or 47 μm or less. The lower limit of the thickness of the first adhesive permeable layer is not particularly limited, and may be within a range satisfying, for example, the weighing range of the first adhesive permeable layer described above.

### Second Adhesive Permeable Layer

The second adhesive permeable layer causes the adhesive (A′) to pass through from one main surface side of the second adhesive permeable layer to the other main surface side when the second adhesive layer expands (foams).

Each configuration of the second adhesive permeable layer may be the same as each configuration of the first adhesive permeable layer.

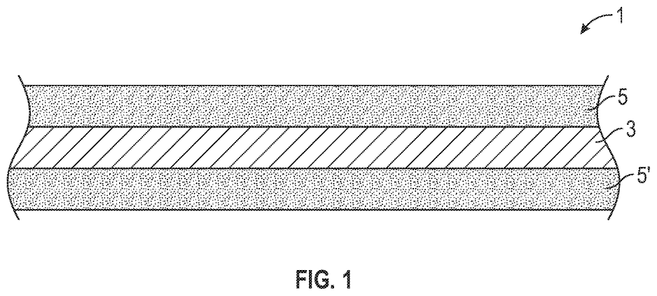

FIG. 1 is a cross-sectional view showing one aspect of the adhesive sheet. The adhesive sheet 1 shown in FIG. 1 includes a substrate 3, a first adhesive layer 5 disposed on one surface of the substrate 3, and a second adhesive layer 5′ disposed on the other side of the substrate 3.

The adhesive sheet 1 shown in FIG. 1 has adhesive strength on both surfaces of the adhesive sheet 1 because the first adhesive layer 5 and the second adhesive layer 5′ are in the outermost layer. By arranging the adhesive sheet 1 between the objects to be adhered and heating them to expand the first adhesive layer 5 and the second adhesive layer 5′, the objects to be adhered to each other while filling the gap between the objects to be adhered can be bonded.

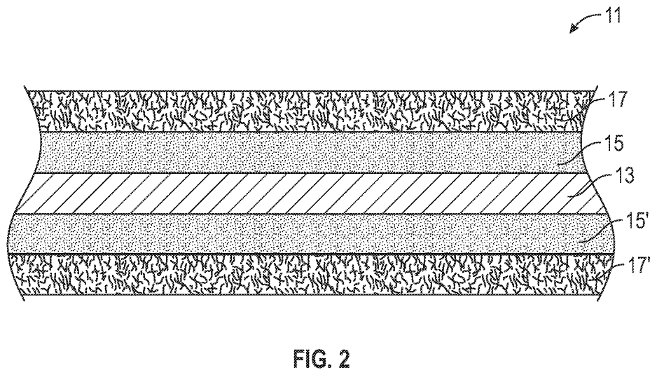

FIG. 2 is a cross-sectional view showing another aspect of the adhesive sheet. The adhesive sheet 11 shown in FIG. 2 includes a substrate 13, a first adhesive layer 15 disposed on one surface of the substrate 13, a second adhesive layer 15′ disposed on the other side of the substrate 13, a first adhesive permeable layer 17 disposed on a surface opposite to the substrate 13 of the first adhesive layer 15, and a second adhesive permeable layer 17′ disposed on the opposite surface of the substrate 13 of the second adhesive layer 15′ are provided.

The adhesive sheet 11 shown in FIG. 2 can be said to be tack-free because the first adhesive permeable layer 17 and the second adhesive permeable layer 17′ are in the outermost layer. By placing the adhesive sheet 11 between the objects to be adhered and heating to expand the first adhesive layer 15 and the second adhesive layer 15′, the adhesive oozes out on the outside of the first adhesive permeation layer 17 and the second adhesive permeable layer 17′. Thereby, the adhesive intervenes between the first adhesive permeable layer 17 and the object to be adhered to, and between the second adhesive permeable layer 17′ and the object to be adhered to, and the adhesive force is exhibited. Thereafter, by curing the adhesive, the objects to be adhered to each other can be bonded.

By heating the adhesive sheet of the present embodiment, a cured foam body of the adhesive sheet can be obtained.

The cured foam body of the present embodiment includes a substrate, a first foam layer formed by foaming and curing the first adhesive layer, and a second foam layer formed by foaming and curing the second adhesive layer.

In the cured foam body of the present embodiment, the first adhesive permeable layer may be embedded in the first foam layer. Further, the cured foam body of the embodiment may have a second adhesive permeable layer embedded in the second foam layer.

The expansion magnification of the adhesive sheet of the present embodiment is not particularly limited, and may be appropriately determined according to the thermal conductivity and adhesive strength required for the foam-cured product, the spacing between the adhesives, and the like. The expansion magnification of the adhesive sheet may be, for example, 1.3 times or more, 1.35 times or more, or 1.4 times or more. Further, the expansion magnification of the adhesive sheet may be, for example, 6.5 times or less, 5.8 times or less, 5.3 times or less, or 4.6 times or less. In the specification, the expansion magnification of the adhesive sheet is a value obtained as a ratio between the thickness of the adhesive sheet and the thickness of the cured foam body in which the adhesive sheet is foam-cured.

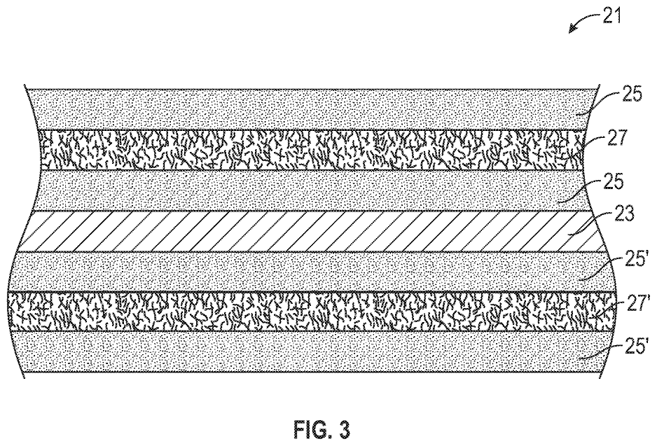

FIG. 3 is a cross-sectional view showing one aspect of the cured foam body. The cured foam body 21 shown in FIG. 3 includes a substrate 23, a first foam layer 25, and a second foam layer 25′. The first adhesive permeable layer 27 is encapsulated in the first foam layer 25, and the second adhesive permeable layer 27′ is encapsulated in the second foam layer 25′.

In FIG. 3, the outer surfaces of the first foam layer 25 and the second foam layer 25′ are smoothly described, but the first foam layer 25 and the second foam layer 25′ may have a shape according to the shape of the object to be adhered in contact with these.

The use of the adhesive sheet of the present embodiment is not particularly limited, and can be used for various applications for adhering the adhered objects to each other. Since the adhesive sheet of the present embodiment is excellent in thermal conductivity after foam curing, it can be suitably used for applications requiring characteristics such as thermal conductivity and heat dissipation.

Further, since the adhesive sheet of the present embodiment is expandable, it can be adapted to the surface shape of the object to be adhered to, and the space between the objects to be adhered can be filled. Further, even if unintentional unevenness occurs on the surface of the object to be adhered, the object to be adhered can be suitably bonded to each other. For this reason, the adhesive sheet of the present embodiment can be suitably used when the object to be adhered has unevenness on the surface or when it is necessary to fill the gap between the adhered objects.

The adhesive sheet of the present embodiment can be suitably used, for example, as a slot liner of the stator core in an electric motor. That is, the adhesive sheet of the present embodiment may be used, for example, to bond the stator core and the winding by arranging between the stator core and the winding.

The electric motor of the present embodiment may include a stator, which includes a stator core having at least one slot, a winding accommodated at least in part in the slot, and an adhesive layer for bonding the stator core and the winding.

The adhesive layer may be a layer formed by foaming and curing of the adhesive sheet. That is, the adhesive layer may be a layer including a cured foam body of the adhesive sheet.

In the electric motor of the present embodiment, each configuration other than the adhesive layer is not particularly limited, and may be the same as each configuration in a known electric motor.

As mentioned above, although preferred embodiments of the present invention have been described, the present invention is not limited to the above embodiment.

The present invention may relate to, for example, the following forms.

[1] An adhesive sheet comprising;
a substrate;
a first adhesive layer disposed on one surface of the substrate and
a second adhesive layer disposed on the other surface of the substrate, wherein
the first adhesive layer includes an adhesive (A), a thermally conductive filler (B) having a mean short side length of 1 μm or more, and a foaming agent (C),
the content of the thermally conductive filler (B) is 1% by volume or more and 37% by volume or less based on the total volume of the first adhesive layer,
the thermally conductive filler (B) includes a filler (B-1) having an aspect ratio of 1.3 or more,
the second adhesive layer includes an adhesive (A′), a thermally conductive filler (B′) having a mean short side length of 1 μm or more, and a foaming agent (C′),
the content of the thermally conductive filler (B′) is 1% by volume or more and 37% by volume or less based on the total volume of the second adhesive layer, and
the thermally conductive filler (B′) includes a filler (B′-1) having an aspect ratio of 1.3 or more.

[2] The adhesive sheet according to [1], wherein
the content of the filler (B-1) is 0.1% by volume or more based on the total volume of the first adhesive layer,
the content of the filler (B′-1) is 0.1% by volume or more based on the total volume of the second adhesive layer.

[3] The adhesive sheet according to [1] or [2], further comprising;
a first adhesive permeable layer disposed on the first adhesive layer and capable of permeable the adhesive (A) when the first adhesive layer foams and
a second adhesive permeable layer disposed on the second adhesive layer and capable of permeating the adhesive (A′) when the second adhesive layer foams.

[4] The adhesive sheet according to [3], wherein
the content of the thermally conductive filler (B) is 1% by volume or more and 30% by volume or less based on the total volume of the first adhesive layer and
the content of the thermally conductive filler (B′) is 1% by volume or more and 30% by volume or less based on the total volume of the second adhesive layer.

[5] The adhesive sheet according to any one of [1] to [4], wherein
the thermally conductive filler (B) contains at least one selected from the group consisting of boron nitride, aluminum nitride and alumina and
the thermally conductive filler (B′) comprises at least one selected from the group consisting of boron nitride, aluminum nitride and alumina.

[6] The adhesive sheet according to any one of [1] to [5], wherein
the filler (B-1) is platelet-shaped, whisker-shaped, or agglomerated and
the filler (B′-1) is platelet-shaped, whisker-shaped, or agglomerated.

[7] The adhesive sheet according to any one of [1] to [6], wherein
the foaming agent (C) includes thermal expansion particles (C-1) and
the foaming agent (C′) includes thermal expansion particles (C′-1).

[8] The adhesive sheet according to any one of [1] to [7], which is a slot liner of the stator core of an electric motor.

[9] The cured foam body of the adhesive sheet according to any one of [1] to [8].

[10] An electric motor comprising a stator, wherein
the stator comprising;
   a stator core having at least one slot;
   a winding accommodated at least in part in the slot and
   an adhesive layer for bonding the stator core and the winding, wherein
the adhesive layer includes a cured foam body of the adhesive sheet according to any one of [1] to [8].

### EXAMPLES

Hereinafter, the present invention will be described in more detail with reference to examples, but the present invention is not limited to these examples.

### Preparation of Adhesive Composition (1)

The materials shown in Table 1 were prepared.

TABLE 1

| trade name | | Sold by |
|---|---|---|
| NPPN442 | Trifunctional epoxy resin | Nan Ya Plastics Corp. |
| YSLV-80XY | Liquid crystal epoxy resin | NIPPON STEEL Chemical & Material Co., Ltd. |
| YP-50EK35 | Phenoxy resin (MEK solution) | NIPPON STEEL Chemical & Material Co., Ltd. |
| BTA731 | Core shell type impact resistance modifier | Dow Chemical Japan Corporation |
| FN-100SSD | Thermal expansion particles | Matsumoto Yushi-Seiyaku Co., Ltd |
| 2MZA-PW | Imidazole curing agents | Shikoku Chemicals Corporation |
| DICY 1400F | Dicyandiamide | Evonik Japan K.K. |
| TS720 | Fumed silica | Cabot Japan K.K. |
| Z6040 | Silane coupling agent | Dow Toray Industries, Inc. |
| MEK | Methyl ethyl ketone | FUJIFILM Wako Pure Chemical Corporation |

BTA731 (core-shell type impact resistance improver) and NPPN442 (trifunctional epoxy resin) were mixed, and then other materials shown in Table 1 were added and mixed with a mixer to obtain an adhesive composition (1). The amount of each material was as shown in Table 2. The blending amount of YP-50EK35 (MEK solution of phenoxy resin, solid content concentration 35% by mass) indicates an amount containing a solvent (MEK).

TABLE 2

| trade name | | Blending amount (part by mass) |
|---|---|---|
| NPPN442 | Trifunctional epoxy resin | 69.3 |
| YSLV-80XY | Crystalline epoxy resin | 0.7 |
| YP-50EK35 | Phenoxy resin (MEK solution) | 20 |
| BTA731 | Core shell type impact resistance modifier | 5 |
| FN-100SSD | Thermal expansion particles | 15 |
| 2MZA-PW | Imidazole curing agents | 0.9 |
| DICY 1400F | Dicyandiamide | 7 |
| TS720 | Fumed silica | 2 |
| Z6040 | Silane coupling agent | 0.4 |
| MEK | Methyl ethyl ketone | 50 |

| | |
|---|---|
| Total quantity | 170.3 |
| Solids content | 107.3 |

### Preparation of Thermally Conductive Filler

The thermally conductive filler shown in Table 3 was prepared.

TABLE 3

| | name | ingredient | shape | Sold by |
|---|---|---|---|---|
| (1) | BN-CFP-012 | Boron nitride | Platelet | 3M Japan Limited |
| (2) | Agglomerate 50 | Boron nitride | Agglomerates | 3M Japan Limited |
| (3) | PTX60 | Boron nitride | spherical | Momentive Performance |
| | | | | Materials |
| (4) | AIN Whisker | Aluminum nitride | Whiskers | u-MAP Co., LTD |
| (5) | HF-01D | Aluminum nitride | spherical | Tokuyama Corporation |
| (6) | CB-P02 | alumina | spherical | Showa Denko K.K. |

The mean short side length, mean long side length and aspect ratio of each thermally conductive filler were obtained by the following method. The results are shown in Table 4.

### Measuring Filler Size

The filler was sprinkled on a conductive double-sided tape attached to the sample table and excess filler was removed with a blower. Next, osmium was coated on the filler using an osmium plasma coater (Japan Laser Electronics Co., Ltd. OPC80N), and the sample was subjected to conductive treatment.

Using a scanning electron microscope (Hitachi High-Tech S3400N), a secondary electron image of the filler was obtained with an accelerating voltage of 10 kV, a working distancing of 10 mm, and an observation magnification range of 100 to 3000 times. From the obtained image, the smallest rectangle (minimum circumscribed rectangle) that can cover the filler was confirmed visually and image analysis, and the long and short sides of the rectangle were determined as the long and short sides of the filler.

For each type of filler, at least three images were acquired, and the long side and short side of 10~30 fillers, totally 50 or more fillers, were measured, and the mean values were the mean long side length and the mean short side length of the filler.

TABLE 4

| | | Mean long side | Mean short side | aspect |
|---|---|---|---|---|
| | name | length (μm) | length (μm) | ratio |
| (1) | BN-CFP-012 | 26.9 | 17.8 | 1.6 |
| (2) | Agglomerate 50 | 98.8 | 65.7 | 1.6 |
| (3) | PTX60 | 56.2 | 47.1 | 1.2 |
| (4) | AIN Whisker | 190.1 | 2.2 | 93.4 |
| (5) | HF-01D | 1.6 | 1.5 | 1.1 |
| (6) | CB-P02 | 2.8 | 2.7 | 1.1 |

### Preparation of Substrate

As a substrate, a 75 μm thick PEN film (trade name: Theonex Q51 manufactured by Teijin Film Solution Co., Ltd.) was prepared.

### Example 1-1

The adhesive composition (1) 100 parts by mass prepared by the above method and 24.9 parts by mass of the thermally conductive filler (1) (content in the adhesive layer is 13.9% by volume) were mixed to obtain a coating solution for forming an adhesive layer. This coating solution was applied to one side of the substrate and dried at 65° C. for 3 minutes and at 90° C. for 3 minutes to form a first adhesive layer. The thickness of the first adhesive layer was 35.5 μm. The thickness of the first adhesive layer is obtained by measuring the thickness of any three points in the A4 size region of the sample after the formation of the first adhesive layer using a tabletop micrometer, and the mean thickness is subtracted from the thickness of the substrate.

Next, a nonwoven fabric sheet (PET, basis weight 23 g/m2) was laminated, heated and pressurized at a roll temperature of 60° C. using a roll laminating machine, to obtain a laminated structure composed of a substrate, a first adhesive layer, and a first adhesive permeable layer.

Next, the coating solution was applied to the other side of the substrate and dried at 65° C. for 3 minutes and at 90° C. for 3 minutes to form a second adhesive layer. The thickness of the second adhesive layer was 35.2 μm. The thickness of the second adhesive layer is measured using a tabletop micrometer for the A4 size region of the sample before and after the formation of the second adhesive layer, and the mean value of the measured value after the formation of the second adhesive layer is subtracted from the mean value of the measured value before the formation of the second adhesive layer.

Thereafter, a nonwoven fabric sheet (PET, basis weight 23 g/m²) was laminated on the second adhesive layer, and a roll type laminating machine was used to heat and press at a roll temperature of 60° C. to obtain an adhesive sheet having a thickness (T1) of 190 μm.

On the obtained adhesive sheet, a measurement test object, expansion magnification, thermal conductivity measurement, and shear strength were measured by the following methods. The results are shown in Table 5.

### Preparation of Measurement Test Specimens

### (1) Preparation of Specimens for Measuring Thermal Conductivity

The adhesive sheet was cut to 50 mm×50 mm. Prepare two fluororesin sheets (Alam Co., Ltd., thickness 0.2 mm), place an adhesive sheet and a spacer having a thickness of 400 μm surrounding the entire circumference of the adhesive sheet on one fluororesin sheet, and another fluororesin sheet is placed on the adhesive sheet. It was placed on a spacer and heat pressed for 10 minutes at 160° C. to obtain a foamed cured product having a thickness (T₂) of 360 μm. This cured foam was used as a test body for measuring thermal conductivity. The thickness (T₂) of the cured foam was measured using the thickness measurement function of the thermal conductivity measuring instrument when measuring the thermal conductivity described later.

### (2) Preparation of Specimens for Shear Tests

The adhesive sheet was cut to 12.5 mm×25 mm. Prepare two SPCC plates (100 mm×25 mm×1.6 mm (conform to JIS G 3141)) whose surface is cleaned with methyl ethyl ketone, and place an adhesive sheet and a spacer having a thickness of 400 μm in order from the end side on one SPCC plate. Another SPCC plate was placed on an adhesive sheet and spacer and heat pressed at 160° C. for 10 minutes to obtain a shear test specimen (JIS K6850 compliant) containing a foamed cured product having a thickness (T₃) of 380 μm. The thickness (T₃) of the cured foam product was obtained by measuring the thickness of the entire specimen for the shear test, and subtracting the thickness (3200 μm) equivalent to two SPCC plates from the measured value.

### Measurement of Expansion Magnification

### (1) Measurement of Expansion Magnification of Cured Foaming Body in a Specimen for Measuring Thermal Conductivity

The expansion magnification was obtained by T₂/T₁ using the thickness of the adhesive sheet (T₁) and the thickness of the cured foam body (T₂).

### (2) Measurement of Expansion Magnification of Cured Foam in a Specimen for Shear Test

The expansion magnification was determined by T₃/T₁ using the thickness of the adhesive sheet (T₁) and the thickness of the cured foam body (T₃) in the shear test specimen.

### Measurement of Thermal Conductivity

Using a thermal conductivity measuring device (Analysis Tech Inc., thermal interface material tester TIM Tester Model 1300), the thermal conductivity of a test specimen for measuring thermal conductivity was measured in accordance with the ASTM D5470.

### Shear Strength Measurement

A material testing machine (RTC-1325A manufactured by ORIENTEC) equipped with a constant temperature test device was used. The measurement sample (shear test specimen) was allowed to stand in the material test machine heated to 200° C. for 10 minutes and sufficiently heated. Thereafter, the shear strength was measured at 200° C. at a shear tensile rate of 5 mm/min.

### Example 1-2

The thermally conductive filler (1) was changed to 24.9 parts by mass of the thermally conductive filler (2) (the content in the adhesive layer was 13.9% by volume), and the thickness of the first adhesive layer was 49 μm.

Regarding the obtained adhesive sheet, a measurement specimen, expansion magnification, thermal conductivity measurement, and shear strength measurement were performed in the same manner as in Example 1-1. The results are shown in Table 5.

### Example 1-3

The thermally conductive filler (1) is changed to a thermally conductive filler (4) 2.0 parts by mass and a thermally conductive filler (5) 34.2 parts by mass (the total content of (4) and (5) in the adhesive layer is 13.9% by volume), the thickness of the first adhesive layer is 45 μm, and the thickness of the second adhesive layer. An adhesive sheet having a thickness (T₁) of 225 μm was produced in the same manner as in Example 1-1 except that the sash was set to 30 μm.

For the obtained adhesive sheet, except that the thickness of the spacer was changed to 440 μm, a measurement specimen for measurement, measurement of expansion magnification, measurement of thermal conductivity, and measurement of shear strength were performed in the same manner as in Example 1-1. The results are shown in Table 5.

### Example 1-4

The thermally conductive filler (1) is changed to 23.5 parts by mass of the thermally conductive filler (1) and 2.0 parts by mass of the thermally conductive filler (4) 2.0 parts by mass (the total content of (1) and (4) in the adhesive layer is 13.9% by volume), and the thickness of the first adhesive layer is 55 μm. An adhesive sheet having a thickness (T₁) of 260 μm was produced in the same manner as in Example 1-1 except that the sash was set to 60 μm.

For the obtained adhesive sheet, except that the thickness of the spacer was changed to 440 μm, a measurement specimen for measurement, measurement of expansion magnification, measurement of thermal conductivity, and measurement of shear strength were performed in the same manner as in Example 1-1. The results are shown in Table 5.

### Comparative Example 1-1

The same as in Example 1-1 except that the thermally conductive filler (1) is not blended and the thickness of the first adhesive layer is 35 μm and the thickness of the second adhesive layer is 38.3 μm. An adhesive sheet having a thickness (T1) of 210 μm was prepared.

Regarding the obtained adhesive sheet, a measurement specimen, expansion magnification, thermal conductivity measurement, and shear strength measurement were performed in the same manner as in Example 1-1. The results are shown in Table 5.

### Comparative Example 1-2

The thermally conductive filler (1) is changed to the thermally conductive filler (3) 24.9 parts by mass (the content in the adhesive layer is 13.9% by volume), the thickness of the first adhesive layer is 43 μm, and the thickness of the second adhesive layer was produced as 42 μm, an adhesive sheet having a thickness (T1) of 220 μm was produced in the same manner as in Example 1-1.

Regarding the obtained adhesive sheet, a measurement specimen, expansion magnification, thermal conductivity measurement, and shear strength measurement were performed in the same manner as in Example 1-1. The results are shown in Table 5.

### Comparative Example 1-3

The thermally conductive filler (1) is changed to 36.2 parts by mass of the thermally conductive filler (5) (the content in the adhesive layer is 13.9% by volume), the thickness of the first adhesive layer is 39 μm, and the thickness of the second adhesive layer is 36 μm. In the same manner as in Example 1-1, an adhesive sheet having a thickness (T₁) of 190 μm was produced.

Regarding the obtained adhesive sheet, a measurement specimen, expansion magnification, thermal conductivity measurement, and shear strength measurement were performed in the same manner as in Example 1-1. The results are shown in Table 5.

### Comparative Example 1-4

The thermally conductive filler (1) was changed to the thermally conductive filler (6) 40.4 parts by mass (the content in the adhesive layer was 13.9% by volume), and the thickness of the first adhesive layer was 30 μm and the thickness of the second adhesive layer was 33.3 μm. Otherwise, in the same manner as in Example 1-1, an adhesive sheet having a thickness (T₁) of 200 μm was produced.

Regarding the obtained adhesive sheet, a measurement specimen, expansion magnification, thermal conductivity measurement, and shear strength measurement were performed in the same manner as in Example 1-1. The results are shown in Table 5.

TABLE 5

| | Example | | | | Comparative example | | | |
|---|---|---|---|---|---|---|---|---|
| | 1-1 | 1-2 | 1-3 | 1-4 | 1-1 | 1-2 | 1-3 | 1-4 |
| Thermally conductive filler | 1 | 2 | 4 + 5 | 1 + 4 | — | 3 | 5 | 6 |
| Thermally conductive filler | 13.9 | 13.9 | 13.9 | 13.9 | — | 13.9 | 13.9 | 13.9 |
| Content (% by volume) | | | | | | | | |
| First adhesive layer | 35.5 | 49 | 45 | 55 | 35 | 43 | 39 | 30 |
| Thickness (μm) | | | | | | | | |
| Second adhesive layer | 35.2 | 49.3 | 30 | 60 | 38.3 | 42 | 36 | 33.3 |
| Thickness (μm) | | | | | | | | |
| Adhesive sheet Thickness | 190 | 220 | 225 | 260 | 210 | 220 | 190 | 200 |
| T₁ (μm) | | | | | | | | |
| Thermal conductivity | | | | | | | | |
| evaluation | | | | | | | | |
| Thickness T₂ (μm) | 360 | 350 | 367 | 383 | 345 | 310 | 333 | 291 |
| Magnification of | 1.9 | 1.6 | 1.6 | 1.5 | 1.6 | 1.4 | 1.8 | 1.5 |
| expansion (T₂/T₁) | | | | | | | | |
| Thermal conductivity | 0.161 | 0.11 | 0.167 | 0.142 | 0.067 | 0.088 | 0.097 | 0.072 |
| (W/mK) | | | | | | | | |
| Shear strength evaluation | | | | | | | | |
| Thickness T₃ (μm) | 380 | 370 | 435 | 390 | 345 | 365 | 378 | 393 |
| Magnification of | 2.0 | 1.7 | 1.9 | 1.5 | 1.6 | 1.7 | 2.0 | 2.0 |
| expansion (T₃/T₁) | | | | | | | | |
| Shear strength (MPa) | 1.15 | 1.31 | 1.2 | 1.9 | 1.15 | 0.28 | 0.58 | 0.01 |

### Example 2-1

The amount of the thermally conductive filler (1) was changed to 50.0 parts by mass (the content in the adhesive layer was 24.5% by volume), the thickness of the first adhesive layer was 39 μm, and the thickness of the second adhesive layer was 44.3 μm. In the same manner as in Example 1-1, an adhesive sheet having a thickness (T1) of 190 μm was produced.

Regarding the obtained adhesive sheet, a measurement specimen, expansion magnification, thermal conductivity measurement, and shear strength measurement were performed in the same manner as in Example 1-1. The results are shown in Table 6.

### Example 2-2

The thermally conductive filler (1) was changed to the thermally conductive filler (2) 49.5 parts by mass (the content in the adhesive layer was 24.3% by volume), the thickness of the first adhesive layer was 48 μm, and the thickness of the second adhesive layer was 57 μm. Otherwise, in the same manner as in Example 1-1, an adhesive sheet having a thickness (T1) of 220 μm was produced.

Regarding the obtained adhesive sheet, a measurement specimen, expansion magnification, thermal conductivity measurement, and shear strength measurement were performed in the same manner as in Example 1-1. The results are shown in Table 6.

### Comparative Example 2-1

The thermally conductive filler (1) was changed to the thermally conductive filler (3) 49.5 parts by mass (the content in the adhesive layer was 24.3% by volume), and the thickness of the first adhesive layer was 85 μm and the thickness of the second adhesive layer was 95 μm. Otherwise, in the same manner as in Example 1-1, an adhesive sheet having a thickness (T1) of 290 μm was produced.

For the obtained adhesive sheet, except that the thickness of the spacer was changed to 480 μm, a measurement test body for measurement, measurement of expansion magnification, measurement of thermal conductivity, and measurement of shear strength were performed in the same manner as in Example 1-1. The results are shown in Table 6.

TABLE 6

| | | Example | | Comparative example |
|---|---|---|---|---|
| | | 2-1 | 2-2 | 2-1 |
| Thermally conductive filler | | 1 | 2 | 3 |
| Thermally conductive filler Content (% by volume) | | 24.5 | 24.3 | 24.3 |
| First adhesive layer Thickness (μm) | | 39 | 48 | 85 |
| Second adhesive layer Thickness (μm) | | 44.3 | 57 | 95 |
| Adhesive sheet Thickness T₁ (μm) | | 190 | 220 | 290 |
| Thermal conductivity evaluation | | | | |
| | Thickness T₂ (μm) | 336 | 353 | 480 |
| | Magnification of expansion (T₂/T₁) | 1.8 | 1.6 | 1.7 |
| | Thermal conductivity (W/mK) | 0.191 | 0.117 | 0.091 |
| Shear strength evaluation | | | | |
| | Thickness T₃ (μm) | 383 | 360 | 470 |
| | Magnification of expansion (T₃/T₁) | 2.0 | 1.6 | 1.6 |
| | Shear strength (MPa) | 0.92 | 0.51 | 0.71 |

### Example 3-1

The amount of the thermally conductive filler (1) was changed to 5.0 parts by mass (the content in the adhesive was 3.1% by volume), the thickness of the first adhesive layer was 31 μm, and the thickness of the second adhesive layer was 35.7 μm.

For the obtained adhesive sheet, except that the thickness of the spacer was changed to 440 μm, a measurement specimen for measurement, measurement of expansion magnification, measurement of thermal conductivity, and measurement of shear strength were performed in the same manner as in Example 1-1. The results are shown in Table 7.

### Example 3-2

The amount of the thermally conductive filler (1) is changed to 5.0 parts by mass (the content in the adhesive is 3.1% by volume), the thickness of the first adhesive layer is 33 μm, and the thickness of the second adhesive layer is 38.7 μm. An adhesive sheet having a thickness (T1) of 190 μm was prepared.

Regarding the obtained adhesive sheet, a measurement specimen, measurement of expansion magnification, measurement of thermal conductivity, and measurement of shear strength were performed in the same manner as in Example 1-1. The results are shown in Table 7.

### Example 3-3

The amount of the thermal conductive filler (1) is changed to 10.0 parts by mass (the content in the adhesive is 6.1% by volume), the thickness of the first adhesive layer is 36 μm, and the thickness of the second adhesive layer is 40.7 μm. An adhesive sheet having a thickness (T1) of 190 μm was prepared.

Regarding the obtained adhesive sheet, a measurement specimen, expansion magnification, thermal conductivity measurement, and shear strength measurement were performed in the same manner as in Example 1-1. The results are shown in Table 7.

### Example 3-4

The amount of the thermally conductive filler (1) was changed to 10.0 parts by mass (the content in the adhesive was 6.1% by volume), and the thickness of the first adhesive layer was 55 μm and the thickness of the second adhesive layer was 50 μm. Otherwise, in the same manner as in Example 1-1, an adhesive sheet having a thickness (T1) of 205 μm was produced.

For the obtained adhesive sheet, except that the thickness of the spacer was changed to 360 μm, a measurement specimen for measurement, measurement of expansion magnification, measurement of thermal conductivity, and measurement of shear strength were performed in the same manner as in Example 1-1. The results are shown in Table 7.

### Reference Example 1

Except that the amount of the thermally conductive filler (1) is changed to 74.5 parts by mass (the content in the adhesive is 32.5% by volume), the thickness of the first adhesive layer is 55 μm, and the thickness of the second adhesive layer is 50 μm. In the same manner as in Example 1-1, an adhesive sheet having a thickness (T1) of 250 μm was produced.

The obtained adhesive sheet was attempted to produce a measurement test object in the same manner as in Example 1-1, but in the adhesive sheet of Reference Example 1, the adhesive oozes from the adhesive permeable layer (nonwoven fabric sheet) even if heated.

### Comparative Example 3-1

Except that the amount of the thermally conductive filler (1) was changed to 104.0 parts by mass (the content in the adhesive was 40.2% by volume), a coating solution was attempted in the same manner as in Example 1-1. However, in Comparative Example 3-1, kneading of the coating solution became difficult, and it was difficult to form an adhesive layer.

TABLE 7

| | | | | | Reference | Comparative |
|---|---|---|---|---|---|---|
| | example of execution | | | | example | example |
| | 3-1 | 3-2 | 3-3 | 3-4 | 1 | 3-1 |
| Thermally conductive filler | 1 | 1 | 1 | 1 | 1 | 1 |
| Thermally conductive filler Content | 3.1 | 3.1 | 6.1 | 6.1 | 32.5 | 40.2 |
| (% by volume) | | | | | | |
| First adhesive layer Thickness (μm) | 31 | 33 | 36 | 55 | 55 | — |
| Second adhesive layer Thickness (μm) | 35.7 | 38.7 | 40.7 | 50 | 50 | — |
| Adhesive sheet Thickness T₁ (μm) | 190 | 190 | 190 | 205 | 250 | — |
| Thermal conductivity evaluation | | | | | | |
| Thickness T₂ (μm) | 380 | 276 | 390 | 282 | — | — |
| Magnification of expansion | 2.0 | 1.5 | 2.1 | 1.4 | — | — |
| (T₂/T₁) | | | | | | |
| Thermal conductivity (W/mK) | 0.078 | 0.088 | 0.090 | 0.108 | — | — |
| Shear strength evaluation | | | | | | |
| Thickness T₃ (μm) | 390 | 360 | 380 | 350 | — | — |
| Magnification of expansion | 2.1 | 1.9 | 2.0 | 1.7 | — | — |
| (T₃/T₁) | | | | | | |
| Shear strength (MPa) | 1.10 | 0.58 | 1.00 | 0.61 | — | — |

### Example 4-1

The adhesive composition (1) 100 parts by mass prepared by the above method and the thermally conductive filler (1) 74.5 parts by mass (content in the adhesive layer is 32.5% by volume) were mixed to obtain a coating solution for forming an adhesive layer. This coating solution was applied to one side of the substrate, dried at 65° C. for 3 minutes and at 90° C. for 3 minutes, and dried to form a first adhesive layer. The thickness of the first adhesive layer was 55 μm. The thickness of the first adhesive layer is obtained by measuring the thickness of any three points in the A4 size region of the sample after the formation of the first adhesive layer using a tabletop micrometer.

Next, the coating solution was applied on the other surface of the substrate and dried at 65° C. for 3 minutes and at 90° C. for 3 minutes to form a second adhesive layer, and an adhesive sheet having a thickness (T1) of 215 μm was obtained. The thickness of the second adhesive layer was 51.7 μm. The thickness of the second adhesive layer is measured using a tabletop micrometer for the A4 size region of the sample before and after the formation of the second adhesive layer, and the mean value of the measured value after the formation of the second adhesive layer is subtracted from the mean value of the measured value before the formation of the second adhesive layer value.

For the obtained adhesive sheet, a measurement test object, measurement of expansion magnification, measurement of thermal conductivity, and measurement of shear strength were performed in the same manner as in Example 1-1 except that the thickness of the spacer was set to 360 μm. The results are shown in Table 8.

### Example 4-2

Except that the amount of the thermally conductive filler (1) was changed to 90.0 parts by mass (the content in the adhesive was 36.8% by volume), the thickness of the first adhesive layer was 45 μm, and the thickness of the second adhesive layer was 40 μm. In the same manner as in Example 4-1, an adhesive sheet having a thickness (T1) of 210 μm was prepared.

For the obtained adhesive sheet, except that the thickness of the spacer was changed to 360 μm, a measurement specimen for measurement, measurement of expansion magnification, measurement of thermal conductivity, and measurement of shear strength were performed in the same manner as in Example 1-1. The results are shown in Table 8.

### Comparative Example 4-1

Except that the amount of the thermally conductive filler (1) was changed to 95.0 parts by mass (the content in the adhesive was 38.1% by volume), a coating solution was attempted in the same manner as in Example 4-1. However, in Comparative Example 4-1, kneading of the coating solution became difficult, and it was difficult to form an adhesive layer.

### Comparative Example 4-2

Except that the amount of the thermally conductive filler (1) was changed to 104.0 parts by mass (the content in the adhesive was 40.2% by volume), a coating solution was attempted in the same manner as in Example 4-1. However, in Comparative Example 4-1, kneading of the coating solution became difficult, and it was difficult to form an adhesive layer.

TABLE 8

| | | | | Comparative | |
|---|---|---|---|---|---|
| | | Example | | example | |
| | | 4-1 | 4-2 | 4-1 | 4-2 |
| Thermally conductive filler | | 1 | 1 | 1 | 1 |
| Thermally conductive filler Content (% by volume) | | 32.5 | 36.8 | 38.1 | 40.2 |
| First adhesive layer Thickness (μm) | | 55 | 45 | — | — |
| Second adhesive layer Thickness (μm) | | 51.7 | 40 | — | — |
| Adhesive sheet Thickness T₁ (μm) | | 215 | 210 | — | — |
| Thermal conductivity evaluation | | | | | |
| | Thickness T₂ (μm) | 340 | 350 | — | — |
| | Magnification of expansion (T₂/T₁) | 1.58 | 1.67 | — | — |
| | Thermal conductivity (W/mK) | 0.256 | 0.32 | — | — |
| Shear strength evaluation | | | | | |
| | Thickness T₃ (μm) | 370 | 370 | — | — |
| | Magnification of expansion (T₃/T₁) | 1.72 | 1.76 | — | — |
| | Shear strength (MPa) | 1.42 | 0.35 | — | — |

### EXPLANATION OF SIGNS

1, 11 . . . Adhesive sheet, 3,13,23 . . . Substrate, 5,15 . . . First adhesive layer, 5′,15′ . . . Second adhesive layer, 17,27 . . . First adhesive permeable layer, 17′,27′ . . . The second adhesive permeable layer, 21 . . . Cured foam, 23 . . . Substrate, 25 . . . 1st foam, 25′ . . . The second foam.

1. An adhesive sheet comprising;
a substrate;
a first adhesive layer disposed on one surface of the substrate and
a second adhesive layer disposed on the other surface of the substrate, wherein
the first adhesive layer includes an adhesive (A), a thermally conductive filler (B) having a mean short side length of 1 μm or more, and a foaming agent (C),
the content of the thermally conductive filler (B) is 1% by volume or more and 37% by volume or less based on the total volume of the first adhesive layer,
the thermally conductive filler (B) includes a filler (B-1) having an aspect ratio of 1.3 or more,
the second adhesive layer includes an adhesive (A′), a thermally conductive filler (B′) having a mean short side length of 1 μm or more, and a foaming agent (C′),
the content of the thermally conductive filler (B′) is 1% by volume or more and 37% by volume or less based on the total volume of the second adhesive layer, and
the thermally conductive filler (B′) includes a filler (B′-1) having an aspect ratio of 1.3 or more.

2. The adhesive sheet according to claim 1, wherein
the content of the filler (B-1) is 0.1% by volume or more based on the total volume of the first adhesive layer,
the content of the filler (B′-1) is 0.1% by volume or more based on the total volume of the second adhesive layer.

3. The adhesive sheet according to claim 1, further comprising;
a first adhesive permeable layer disposed on the first adhesive layer and capable of permeable the adhesive (A) when the first adhesive layer foams and
a second adhesive permeable layer disposed on the second adhesive layer and capable of permeating the adhesive (A′) when the second adhesive layer foams.

4. The adhesive sheet according to claim 3, wherein
the content of the thermally conductive filler (B) is 1% by volume or more and 30% by volume or less based on the total volume of the first adhesive layer and
the content of the thermally conductive filler (B′) is 1% by volume or more and 30% by volume or less based on the total volume of the second adhesive layer.

5. The adhesive sheet according to claim 1, wherein
the thermally conductive filler (B) contains at least one selected from the group consisting of boron nitride, aluminum nitride and alumina and
the thermally conductive filler (B′) comprises at least one selected from the group consisting of boron nitride, aluminum nitride and alumina.

6. The adhesive sheet according to claim 1, wherein
the filler (B-1) is platelet-shaped, whisker-shaped, or agglomerated and
the filler (B′-1) is platelet-shaped, whisker-shaped, or agglomerated.

7. The adhesive sheet according to claim 1, wherein
the foaming agent (C) includes thermal expansion particles (C-1) and
the foaming agent (C′) includes thermal expansion particles (C′-1).

8. (canceled)

9. The cured foam body of the adhesive sheet according to claim 1.

10. An electric motor comprising a stator, wherein
the stator comprising;
a stator core having at least one slot;
a winding accommodated at least in part in the slot and
an adhesive layer for bonding the stator core and the winding, wherein
the adhesive layer includes a cured foam body of the adhesive sheet according to claim 1.
